(19) United States
(12) Patent Application Publication
(10) Pub. No.: US 2025/0330833 A1
(43) Pub. Date: Oct. 23, 2025

(54) USER EQUIPMENT AND BASE STATION CONFIGURED TO PERFORM BEAMFORMING AND OPERATING METHODS THEREOF

(71) Applicant: Samsung Electronics Co., Ltd., Suwon-si (KR)

(72) Inventors: Leechun KIM, Suwon-si (KR); Seongho HUR, Suwon-si (KR)

(73) Assignee: Samsung Electronics Co., Ltd., Suwon-si (KR)

(21) Appl. No.: 19/184,736

(22) Filed: Apr. 21, 2025

(30) Foreign Application Priority Data
Apr. 22, 2024 (KR) 10-2024-0053546
Jul. 26, 2024 (KR) 10-2024-0099635

(51) Int. Cl. H04W 16/28; H04W 88/08

(52) U.S. Cl. CPC H04W 16/28; H04W 88/08

(57) ABSTRACT

A user equipment (UE) includes an antenna array configured to form at least one horizontal beam with different frequency bands during a first time period, and processing circuitry configured to receive a signal using the at least one horizontal beam, determine a quantity of horizontal beams for receiving the signal, the at least one horizontal beam including the quantity of horizontal beams, and determine a horizontal tilting angle of each among the at least one horizontal beam based on a K-mean clustering algorithm, the K-mean clustering algorithm having a signal-to-interference-plus-noise ratio (SINR) of the at least one horizontal beam as an objective function.

### CROSS-REFERENCE TO RELATED APPLICATION

This application is based on and claims priority under 35 U.S.C. § 119 to Korean Patent Applications No. 10-2024-0053546 filed on Apr. 22, 2024, and Korean Patent Application No. 10-2024-0099635 filed on Jul. 26, 2024, in the Korean Intellectual Property Office, the disclosures of which are incorporated by reference herein in their entireties.

### BACKGROUND

The inventive concepts relate to wireless communication, and more particularly, to a communication device configured to perform beamforming and an operating method of the communication device.

In order to meet increasing demand with respect to wireless data traffic, communication systems implemented in ultra high frequency (UHF) bands are being developed. To reduce path loss of radio waves in the ultra high frequency bands and increase a transmission distance of radio waves, techniques, such as beamforming, massive multi-input multi-output (MIMO), and full dimensional-MIMO (FD-MIMO) are being discussed in 5th Generation (5G) communication systems.

In an FD-MIMO system, a base station may achieve excellent spatial multiplexing at a higher transmission rate by performing beamforming and power allocation. In particular, research is being conducted on a method of maximizing (or increasing) the throughput of a communication system by applying antenna tilting according to a position of the terminal, and an algorithm for determining an optimal (or improved) tilting angle that maximizes (or increases) the throughput of the communication system is also being developed.

A base station including a plurality of antennas may perform a beamforming operation to transmit transmission signals to a plurality of user equipments (UEs). The beamforming operation may refer to a method of transmitting signals having directionality to the plurality of antennas, and the base station may transmit a downlink signal in a beamforming manner to a UE configured to perform wireless communication.

A UE including the plurality of antennas may perform a beamforming operation to receive signals. The UE may receive a downlink signal in a beamforming manner to perform wireless communication.

### SUMMARY

The inventive concepts provide a user equipment (UE) and an operating method of the UE, which may optimize (or increase) the throughput of a wireless communication system by flexibly applying a plurality of horizontal antenna tilting angles according to the location of a cell.

The inventive concepts also provide a base station and an operating method of the base station, which may optimize (or increase) the throughput of a wireless communication system by flexibly applying a plurality of horizontal antenna tilting angles according to the location of a UE.

According to an aspect of the inventive concepts, there is provided a UE including an antenna array configured to form at least one horizontal beam with different frequency bands during a first time period, and processing circuitry configured to receive a signal using the at least one horizontal beam, determine a quantity of horizontal beams for receiving the signal, the at least one horizontal beam including the quantity of horizontal beams, and determine a horizontal tilting angle of each among the at least one horizontal beam based on a K-mean clustering algorithm, the K-mean clustering algorithm having a signal-to-interference-plus-noise ratio (SINR) of the at least one horizontal beam as an objective function.

According to an aspect of the inventive concepts, there is provided a base station including an antenna array configured to simultaneously form a first horizontal beam and a second horizontal beam with a same frequency band during a first time period, or form at least one horizontal beam with different frequency bands during the first time period, and processing circuitry configured to transmit a signal using double beams including the first horizontal beam and the second horizontal beam, or the at least one horizontal beam, and first determine a horizontal tilting angle of each of the first horizontal beam and the second horizontal beam based on a first K-mean clustering algorithm, the first K-mean clustering algorithm including signal-to-interference-plus-noise ratios (SINRs) of the first horizontal beam and the second horizontal beam as an objective function, and inter-beam interference (IBI) between the first horizontal beam and the second horizontal beam as a variable of the objective function, or second determine a horizontal tilting angle of each of the at least one horizontal beam based on a second K-mean clustering algorithm having an SINR of the at least one horizontal beam as an objective function.

According to an aspect of the inventive concepts, there is provided an operating method of a base station. The method includes forming beams, the forming of the beams including simultaneously forming a first horizontal beam and a second horizontal beam with a same frequency band during a first time period, or forming at least one horizontal beam with different frequency bands during the first time period, transmitting a signal by using double beams including the first horizontal beam and the second horizontal beam, or the at least one horizontal beam, and performing a first determination or a second determination, the first determination including determining a horizontal tilting angle of each of the first horizontal beam and the second horizontal beam based on a first K-mean clustering algorithm, the first K-mean clustering algorithm including signal-to-interference-plus-noise ratios (SINRs) of the first horizontal beam and the second horizontal beam as an objective function, and inter-beam interference (IBI) between the first horizontal beam and the second horizontal beam as a variable of the objective function, and the second determination including determining a horizontal tilting angle of each of the at least one horizontal beam based on a second K-mean clustering algorithm having an SINR of the at least one horizontal beam as an objective function.

### BRIEF DESCRIPTION OF THE DRAWINGS

Embodiments will be more clearly understood from the following detailed description taken in conjunction with the accompanying drawings in which:

FIG. 1 is a block diagram of a wireless communication system according to embodiments;

FIGS. 2A to 2D illustrate a base station configured to scan double beams, a user equipment (UE), and a communication system including the base station and the UE, according to embodiments;

FIGS. 3A to 3C illustrate double-beam patterns according to a beam width and a side lobe level (SLL) of a base station;

FIGS. 3D to 3F illustrate double-beam patterns according to a beam width and an SLL of a UE;

FIG. 4 is a table showing optimal (or improved) horizontal tilting angles relative to the number of UEs included in clusters;

FIG. 5 is a graph of a double-beam pattern when an SLL is not applied, according to embodiments;

FIG. 6A is a flowchart of a practical K-means interference avoidance (P-KIA) algorithm for fractional frequency double-beams tilting (FFDT) for obtaining an optimal (or improved) horizontal tilting angle of a double-beam pattern of FIGS. 3A to 3F;

FIG. 6B is a flowchart of a P-KIA algorithm for conventional double-beams tilting (CDT) for obtaining an optimal (or improved) horizontal tilting angle of the double-beam pattern of FIGS. 3A to 3F;

FIG. 6C is a flowchart of a P-KIA algorithm by which FFDT and CDT are performed in parallel;

FIG. 7 illustrates an operating method of a base station according to embodiments;

FIG. 8 is a graph of a mean cell throughput relative to the number of cells, according to embodiments;

FIG. 9 is a graph of a mean cell throughput relative to the number of synchronization signal blocks (SSBs), according to embodiments;

FIG. 10 is a block diagram of a configuration of a wireless communication device according to embodiments;

FIG. 11 is a block diagram of a configuration of a communication device according to embodiments; and

FIG. 12 is a block diagram of a communication device according to embodiments.

### DETAILED DESCRIPTION

Hereinafter, embodiments will be described in detail with reference to the accompanying drawings.

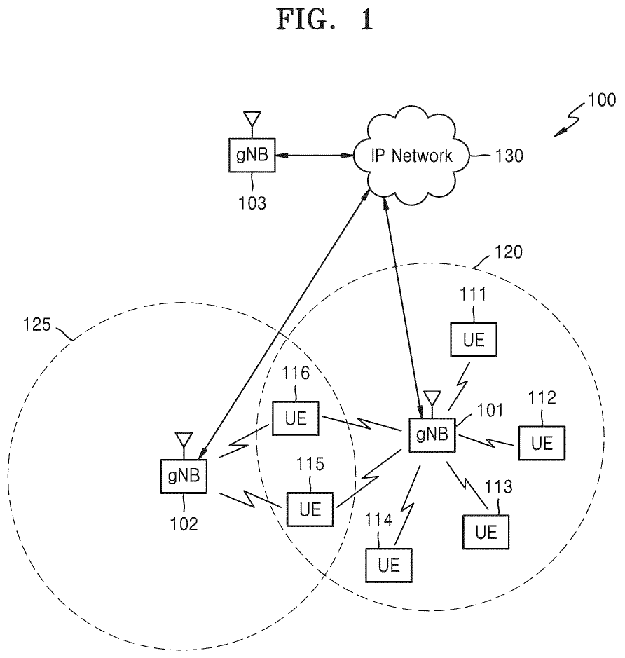

FIG. 1 is a block diagram of a wireless communication system 100 according to embodiments.

Referring to FIG. 1, the wireless communication system 100 may include a first network 120, a second network 125 and user equipments (UEs) 111 to 116. The wireless communication system 100 may be referred to as a multi-input multi-output (MIMO) system.

The wireless communication system 100 may be, but not limited thereto, a 5th generation new radio (5G NR) wireless communication system, a 4th generation long term evolution (4G LTE) wireless communication system, a code division multiple access (CDMA) system, a wideband code division multiple access (WCDMA) system, a global system for mobile communications (GSM) system, a wireless local area network (WLAN) system, any other wireless communication system, or a combination thereof.

In embodiments, the wireless communication system 100 may include a plurality of base stations (e.g., a first base station 101, a second base station 102, and a third base station 103). The first and second base stations 101 and 102 may communicate with a plurality of UEs 111 to 116. As an example, the first base station 101 may be an entity that allocates communication network resources to the first UE 111 and may refer to a fixed station, which communicates with the first UE 111 and/or another base station (e.g., the second base station 102). As another example, the third base station 103 may communicate with an Internet protocol (IP) network 130, such as the Internet, a private IP network, or another data network. In addition, the first base station 101 may communicate with another base station (e.g., the third base station 103) and exchange data and control information with the other base station. The plurality of base stations (e.g., the first to third base stations 101, 102, and 103 may also be each referred to as Node B, evolved-Node B (eNB), next generation Node B (gNB), a sector, a site, a base transceiver system (BTS), an access point (AP), a relay node, a remote radio head (RRH), a radio unit (RU), a small cell, or the like. As used herein, the base station may be broadly interpreted as a partial region or function covered by a base station controller (BSC) in CDMA, a Node-B in WCDMA, eNB in 4G LTE, gNB or a sector (site) in 5G NR, and comprehend all of various coverage regions, such as mega cells, macro cells, micro cells, pico cells, femto cells, relay nodes, RRHs, RUs, small cell communication ranges.

As shown in FIG. 1, the first base station 101 may be included in the first network 120, and the second base station 102 may be included in the second network 125. As an example, the UE 116 may connect to the first network 120 through the first base station 101 and also, may connect the second network 125 through the second base station 102. A coverage region of the first network 120 and/or the second network 125 may be illustrated by a dashed circuit in FIG. 1. However, the coverage region of the first network 120 or the second network 125 is not limited to the example of FIG. 1 and may include other shapes including irregular shapes according to a configuration and a modified example of a base station. UEs 115 and 116 may communicate with the first network 120 and the second network 125 according to arbitrary (or otherwise, given) radio access technology (RAT). In embodiments, the UEs 115 and 116 may communicate with the first network 120 and the second network 125 according to the same RAT (or similar RATs). In embodiments, the UEs 115 and 116 may communicate with the first network 120 and the second network 125 according to different RATs. In the first network 120 or the second network 125, the UEs 111 to 116 may transmit information in various multiple access manners, such as code division multiple access (CDMA), wideband code division multiple access (WCDMA), frequency division multiple Access (FDMA), time division multiple access (TDMA), orthogonal frequency division multiple access (OFDMA), single carrier frequency division multiple access (SC-FDMA), OFDM-FDMA, OFDM-TDMA, and OFDM-CDMA. In this case, the UEs 111 to 116 and the first and second base stations 101 and 102 may communicate with each other and transmit and receive signals (or data) through various channels.

Each of the UEs 111 to 116 may be a wireless communication device and may be defined as an entity that communicates with base station(s) (e.g., the first base station 101 and/or the second base station 102) and/or other UEs. The UEs 111 to 116 may refer to any device that may be fixed or mobile and may transmit and receive data and/or control information by wirelessly communicating with the first and second base stations 101 and 102. For example, each of the UEs 111 to 116 may be referred to as a terminal, terminal equipment, a mobile station (MS), a mobile terminal (MT), a user terminal (UT), a subscribe station (SS), a wireless device, a handheld device, etc.

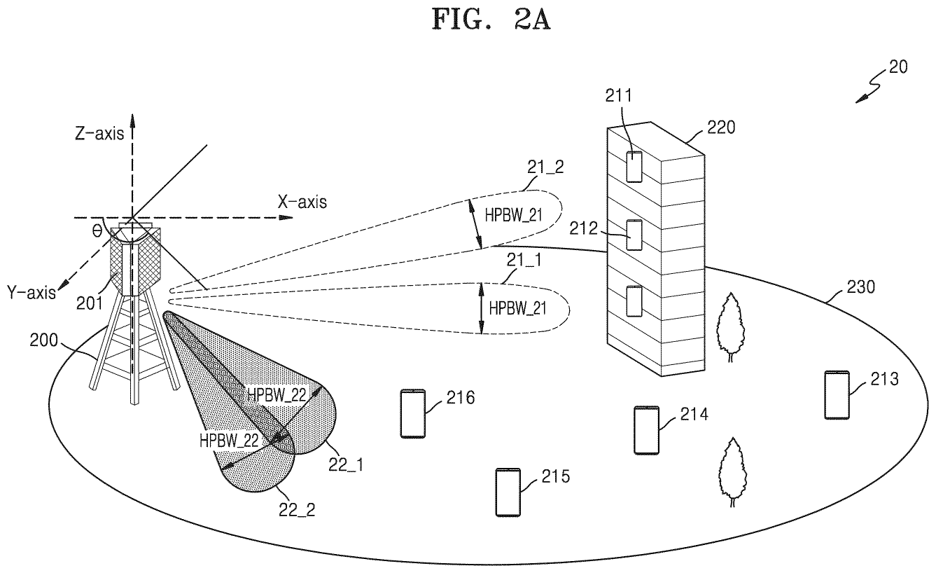

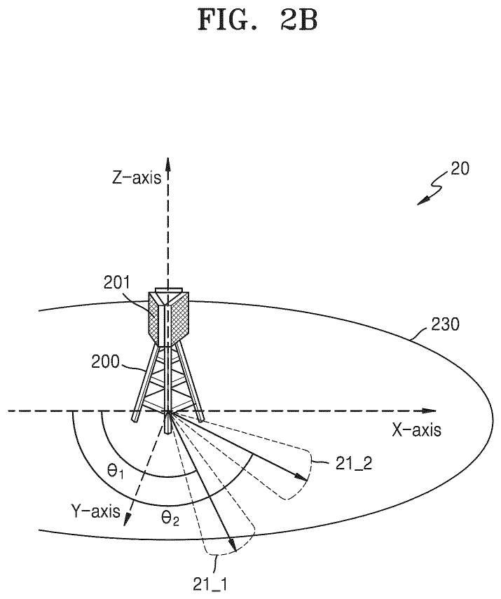

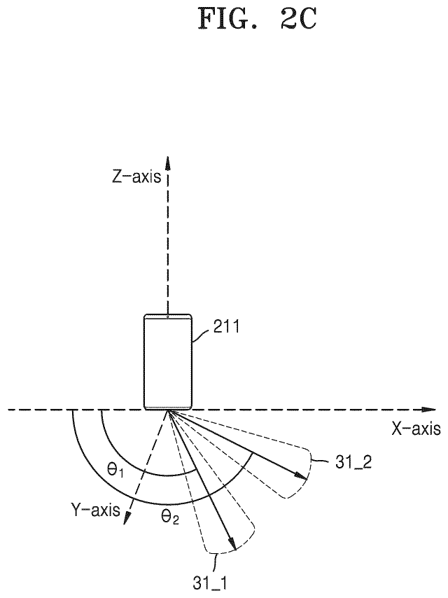

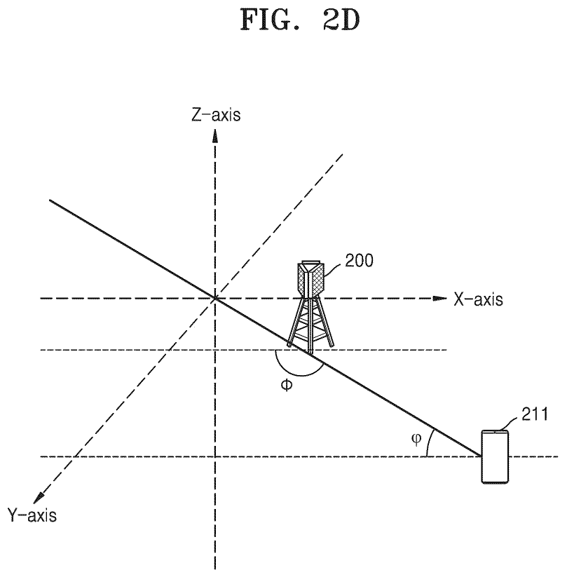

The description below will focus on the first base station 101 and the UE 111 as communication entities to which the inventive concepts are applied. From among examples described with reference to FIGS. 2A and 2D and below, examples that pertain to transmission beamforming of the first base station 101 assume a single cell scenario and will be described with a focus on a communication system including one base station (e.g., the first base station 101) and a plurality of UEs (e.g., 111 to 114) in a coverage region (or cell) covered by the first network 120 without considering interference by the second network 125. However, the inventive concepts are not limited thereto and may also be applied to a dual cell scenario.

FIGS. 2A to 2D illustrate a base station configured to scan double beams, a UE, and a communication system 20 including the base station and the UE, according to embodiments. Hereinafter, FIGS. 2A to 2D are described with reference to FIG. 1.

Referring to FIGS. 2A, 2B, and 2C, the communication system 20 according to embodiments may include a base station 200 and a plurality of UEs 211 to 216. Although six UEs 211 to 216 are illustrated as an example, the number of UEs included in each cell is not limited to six and may vary. In the communication system 20 according to the inventive concepts, each cell may be assumed to support Nₜ UEs (e.g., 211˜216), which are horizontally distributed in a three-dimensional (3D) space. According to embodiments, UEs 211 and 212 may also be vertically distributed in the 3D space (e.g., inside of a building 220). Indices i of the UEs may be 1, 2, . . . , and Nₜ, respectively. Each of Nₜ UEs (e.g., 211 to 216) may not include an isotropic antenna but include a beamforming antenna.

As an example, the communication system 20 may be a full-dimensional multiple-input multiple-output (FD-MIMO) system, and a central frequency and a channel bandwidth may be denoted by f_{c} and B_{w}, respectively. FD-MIMO may be a technique of increasing the capacity of a wireless communication system. The FD-MIMO may correspond to a technique of transmitting and receiving larger amounts of data at higher speed by utilizing beams with a 3D structure using a plurality of antennas.

The base station 200 may be a first base station (refer to 101 in FIG. 1) and include an antenna device 201. The base station 200 may support FD-MIMO, and the antenna device 201 included in the base station 200 may include a plurality of active antenna arrays in a two-dimensional (2D) region. As an example, the base station 200 may transmit and receive signals by using double-beam-based horizontal beamforming.

The antenna device 201 may include at least one transmission antenna and at least one receiving antenna. At least one antenna included in the antenna device 201 (alternatively, the antenna device 201) may operate based on beamforming and scan a formed beam. As an example, the antenna device 201 may include an antenna array configured to form a plurality of beams 21_1, 21_2, 22_1, and 22_2 based on beamforming.

The UE 211 may be one of a plurality of UEs (refer to 111 to 116 in FIG. 1 and refer to 211 to 216 in FIG. 2A) and include an antenna device. The UE 211 may support FD-MIMO, and an antenna device included in the UE 211 may include a plurality of active antenna arrays in a 2D region. As an example, the UE 211 may receive signals by using double-beam-based horizontal beamforming. The UE 211 may not include an isotropic antenna but include a beamforming antenna.

The base station 200 and the UE 211 may determine an optimal (or improved) horizontal tilting angle of each horizontal beam by a conventional double-beams tilting (CDT) technique using two horizontal beams. As used herein, the optimal (or improved) horizontal tilting angle may refer to the horizontal tilting angle of a horizontal beam that provides the highest mean cell throughput. The base station 200 (or the antenna device 201 included in the base station 200) and the UE 211 may each scan double beams with an optimal (or improved) horizontal angle. A horizontal tilting angle θ may refer to a horizontal angle between an arbitrary (or alternatively, given) beam scanned by the base station 200 or the UE 211 and an x-axis. CDT is a technique of maximizing (or increasing) the cell throughput of the base station 200 by allowing a plurality of UEs 211 to 216 to reuse the same resources (or similar resources) in a single cell 230 by using two beams during an arbitrary (or alternatively, given) slot (e.g., a first slot). The reuse of the resources by using double beams may cause inter-beam interference (IBI), which may be a factor in performance degradation of the base station 200. An optimal (or improved) horizontal tilting angle given by the CDT technique may be determined by using a K-means Interference Avoidance (KIA) algorithm considering double-beam IBI, and a detailed description of the KIA algorithm is described below.

The base station 200 may determine an optimal (or improved) horizontal tilting angle of each horizontal beam by a fractional frequency double-beams tilting (FFDT) technique using two horizontal beams, and the base station 200 (or the antenna device 201 included in the base station 200 may scan double beams with an optimal (or improved) horizontal angle. In CDT, double beams may share the entire frequency band in the single cell 230. By comparison, in FFDT, respective beams may have different frequency bands by splitting the entire frequency band in the single cell 230. Considering FFDT from the viewpoint of receiving-beamforming (Rx-beamforming) of the UE 211, the UE 211 may perform separate beamforming on each of a primary cell and a secondary cell. This may be due to the fact that the primary cell and the secondary cell have different frequency bands. An optimal (or improved) horizontal tilting angle given by an FFDT technique may correspond to a special case of the KIA algorithm considering double-beam IBI, and a sub-optimal solution may be obtained by the FFDT technique.

Referring to FIG. 2B, the base station 200 may form and scan a first beam 21_1 with a first horizontal angle θ), and a first beam width and a second beam 21_2 with a second horizontal angle θ, and a second beam width during an arbitrary (or alternatively, given) slot (e.g., the first slot).

Referring to FIG. 2C, the UE 211 may form and scan a first beam 31_1 having the first horizontal angle θ₁ and the first beam width and a second beam 31_2 having the second horizontal angle θ₂ and the second beam width during an arbitrary (or alternatively, given) slot (e.g., the first slot).

Referring to FIG. 2D, Ø denotes a horizontal angle between an x-axis of the base station 200 and the UE 211, and φ denotes a horizontal angle between an x-axis of the UE 211 and the base station 200. For example, ϕᵢ denotes a horizontal angle between the x-axis of the base station 200 and an i-th UE 211, and φᵢ denotes a horizontal angle between an x-axis of the i-th UE 211 and the base station 200.

As used herein, the term “beam width” refers to a half-power beam width (HPBW). The HPBW may refer to an angle at which power in a maximum (or highest) beam direction is reduced by half (10*log (0.5)=−3 dB), and may correspond to an indicator of beam width. Double beams 21_1 and 21_2 scanned during an arbitrary (or alternatively, given) slot may be assumed to have the same beam width (or similar beam widths). As an example, the first beam 21_1 and the second beam 21_2 may have the same beam width HPBW_21.

Similar to the first beam and the second beam described above, the base station 200 may form and scan a third beam 22_1 with a third horizontal angle and a third beam width and a fourth beam 22_2 with a fourth horizontal angle and a fourth beam width during an arbitrary (or alternatively, given) slot (e.g., a second slot). The third beam 22_1 and the fourth beam 22_2 scanned during an arbitrary (or alternatively, given) slot (e.g., the second slot) may be assumed to have the same beam width (or similar beam widths). As an example, the third beam 22_1 and the fourth beam 22_2 may have the same beam width HPBW_22.

An antenna pattern of the base station 200 may be expressed as an antenna gain that reaches the UE 211 from the base station 200. Respective gains of the base station 200 and the UE 211 may be expressed as shown in the following Equations 1a and 1b:

$${G}_{i} ( θ ) = - min ( 12 {( \frac{{ϕ}_{i} - θ}{{ϕ}_{3 dB}} )}^{2} , {SLL}_{gNB} ) \qquad [ Equation 1 a ]$$

$${G}_{i} ( {θ}_{i} ) = - min ( 12 {( \frac{{φ}_{i} - {θ}_{i}}{{φ}_{3 dB}} )}^{2} , {SLL}_{UE} ) \qquad [ Equation 1 b ]$$

Referring to Equations 1a and 1b, θ denotes a horizontal angle that may be adjusted by the base station 200. θ′ᵢ denotes a horizontal angle that may be adjusted by the i-th UE 211. θ₁ and θ₂ denote respective horizontal angles of double beams when the double beams are used in the base station 200. θ′_{i,1} and θ′_{i,2} denote respective horizontal angles of double beams when the double beams are used in the i-th UE 211. When the double beams are used in the i-th UE 211, θ′_{i,1} and θ′_{i,2} may have the same value (or similar values). θ₂ may be greater than or equal to θ₁(θ₁≤θ₂).

ϕᵢ denotes a horizontal angle of the x-axis of the base station 200 and the i-th UE 211, and φᵢ denotes a horizontal angle between the x-axis of the i-th UE 211 and the base station 200. φ_{3 dB} and θ_{3 dB} (and/or ϕ_{3 dB}) each denotes a half-power beam width (HPBW). SLL_{gNB} refers to a horizontal side lobe level (SLL) of the base station 200. SLL_{UE} refers to a horizontal SLL of the UE 211. The SLL may be defined as a ratio of a peak amplitude of a side lobe to a peak amplitude of a main lobe and may be expressed in decibels (dB).

The base station 200 may increase the cell throughput of the base station 200 and load balancing performance by determining the optimal (or improved) horizontal tilting angle of each of the double beams.

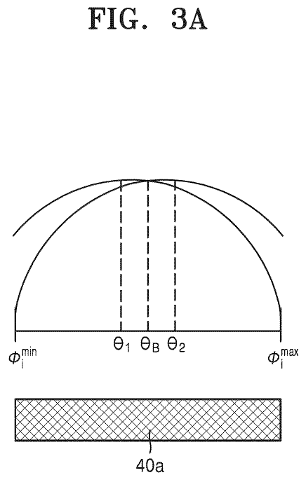

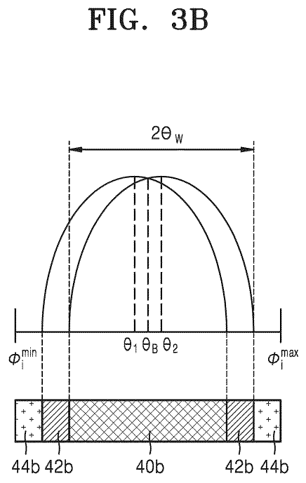

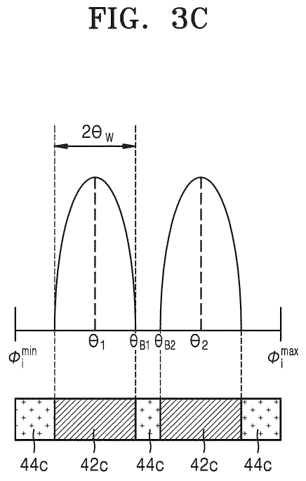

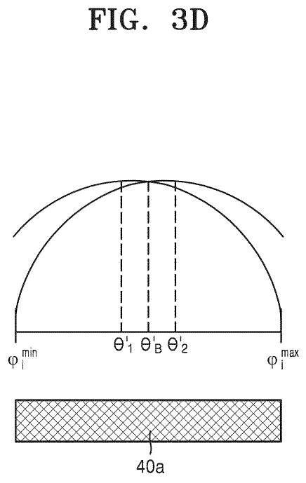

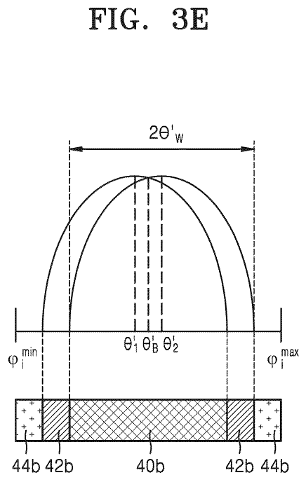

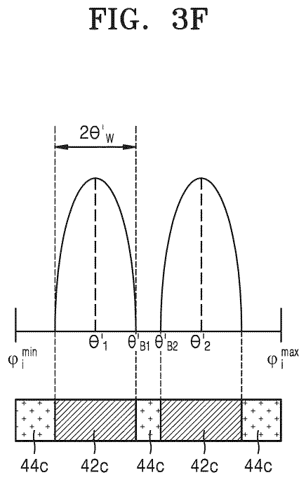

A method of optimizing (or improving) a horizontal tilting angle for improving cell throughput, according to embodiments, may be applied to double-beam patterns shown in FIGS. 3A to 3C. In other words, the base station (refer to 200 in FIG. 2B) and the UE 211 according to embodiments may determine optimal (or improved) horizontal tilting angles of all typical beam patterns, and transmit and receive signals using beams to which the optimal (or improved) horizontal tilting angle is applied.

According to embodiments, a method of obtaining the optimal (or improved) horizontal tilting angle may be performed using a KIA algorithm. The KIA algorithm according to embodiments may correspond to an algorithm using K-mean clustering. The K-mean clustering may be an algorithm by which respective pieces of data are grouped after the data is received. In the K-mean clustering, the data may be assigned to K clusters such that a distance difference between the center of a cluster to which the data belongs and the data is minimized (or reduced).

FIGS. 3A to 3C illustrate double-beam patterns according to a beam width and an SLL of a base station. FIGS. 3D to 3F illustrate double-beam patterns according to a beam width and an SLL of a UE.

FIGS. 3A to 3C illustrate double beams having different horizontal tilting angles (θ₁, θ₂) with respect to a transmission beam of a base station 200. FIGS. 3D to 3F illustrate double beams having different horizontal tilting angles (θ₁, θ₂) with respect to a receiving beam of a UE 211. In FIGS. 3A to 3F, an abscissa denotes a horizontal angle. FIGS. 3A to 3C each illustrate interference between beams with respect to a 3 dB beam width ϕ_{3 dB} and an SLL_{gNB}. FIGS. 3D to 3F each illustrate interference between beams with respect to a 3 dB beam width and an SLL_{UE}.

$${∅}_{i}^{min}$$

may refer to a smallest value in an angle range from which a UE may be derived from the viewpoint of a base station.

$${∅}_{i}^{max}$$

may refer to a greatest value in an angle range from which the UE may be derived from the viewpoint of the base station.

$${φ}_{i}^{min}$$

may refer to a smallest value in an angle range from which the base station may be derived from the viewpoint of the UE,

$${φ}_{i}^{max}$$

may refer to a greatest value in an angle range from which the base station may be derived from the viewpoint of the UE. θ_{B} may be referred to as a “boundary angle” or a “boundary horizontal angle,” and there may be one (e.g., θ_{B}) or more (e.g., θ_{B}_{₁} and θ_{B}_{₂}) boundary angles according to the double-beam pattern. The boundary angle θ_{B} may be calculated by

$${θ}_{B} = \frac{{θ}_{1} + {θ}_{2}}{2} .$$

That is, the boundary angle θ_{B}, may refer to the average of θ₁ and θ₂. Accordingly, a boundary angle θ_{B} between clusters may be determined by θ₁ and θ₂.

FIG. 3A shows a double-beam pattern when an SLL SLL_{gNB} is not applied from the viewpoint of the base station in a possible range of a horizontal angle assuming that a half-power beam width θ_{3dB} is sufficiently great. According to embodiments, θ_{3 dB} may correspond to the half-power beam width ϕ_{3db} discussed in connection with FIGS. 2A-2D. FIG. 3A may be referred to as Case 1. FIGS. 3B and 3C show double-beam patterns when the SLL SLL_{gNB} is applied in a possible range of a horizontal angle assuming that the half-power beam width θ_{3dB} is less than in Case 1. FIGS. 3B and 3C may be respectively referred to as Case 2 and Case 3. The double-beam patterns (e.g., Case 1 to Case 3) may be determined by the half-power beam width θ_{3db} and an SLL SLL_{gNB}. According to another example, the double-beam patterns may be determined by the half-power beam width θ_{3db} and an SLL SLL_{UE}.

In FIGS. 3A to 3C, 2θ_{W} denotes a horizontal beam width when SLL_{gNB} is applied in a possible range of a horizontal angle, and may be expressed as in Equation 2:

$${θ}_{W} = {θ}_{3 dB} \sqrt{{SLL}_{gNB} / 12} \qquad [ Equation 2 ]$$

In Cases 1 to 3, θ_{B}_{₁} and θ_{B}_{₂}, may be introduced for the mathematical expansion for obtaining an optimal (or improved) horizontal tilting angle. It is assumed that if θ₁+θ_{W}<θ_{B}, then θ_{B}_{₁}=θ₁+θ_{W}, and if θ₁+θ_{W}>θ_{B}, then θ_{B}_{₁}=θ_{B}. Similarly, it is assumed that if θ₂−θ_{W}>θ_{B}, then θ_{B}_{₂}=θ₂−θ_{W}, and if θ₂−θ_{W}<θ_{B}, then θ_{B}_{₂}=θ_{B}. That is, θ_{B}_{₁}=θ_{B}_{₂}=θ_{B} may be satisfied in Cases 1 and 2, and θ_{B}_{₁}=θ₁+θ_{W} and θ_{B}_{₂}=θ₂−θ_{W} may be satisfied in Case 3. N₁ denotes the number of UEs in which a horizontal angle ϕᵢ satisfies an inequality θ₁−θ_{W}<ϕᵢ<θ_{B}_{₁}, N2 denotes the number of UEs in which the horizontal angle ϕᵢ satisfies an inequality θ_{B}_{₁}<ϕᵢ<θ₁+θ_{W}, N3 denotes the number of UEs in which the horizontal angle ϕᵢ satisfies an inequality θ₂−θ_{W}<ϕᵢ<θ_{B}_{₂}, and N4 denotes the number of UEs in which the horizontal angle ϕᵢ satisfies an inequality θ_{B}_{₂}<ϕᵢ<θ₂+θ_{W}.

An equation for obtaining (θ′₁, θ′₂) may include a signal-to-interference ratio (SIR) of an i-th UE, and SIR values of respective UEs in Cases 1 to 3 may have different values for each area distinguished by a horizontal angle. As an example, an equation for deriving an SIR value may be different depending on each area is an area (e.g., 40a of Case 1 or 40b of Case 2) where a main lobe of a first beam overlaps a main lobe of a second beam, an area (e.g., 42b of Case 2 or 42c of Case 3) where the main lobe of the first beam (or the second beam) overlaps a side lobe of the second beam (or the first beam), or an area (e.g., 44b of Case 2 or 44c of Case 3) where the side lobe of the first beam overlaps the side lobe of the second beam.

FIGS. 3D to 3F illustrate double-beam patterns relative to a beamwidth and an SLL of the UE 211. Horizontal angles θ′_{i,1}, θ′_{i,2}, θ′_{i,B}, and θ′_{i,W} related to an i-th UE 211 may be defined in the same manner as (or a similar manner to) that described above, and redundant description is omitted.

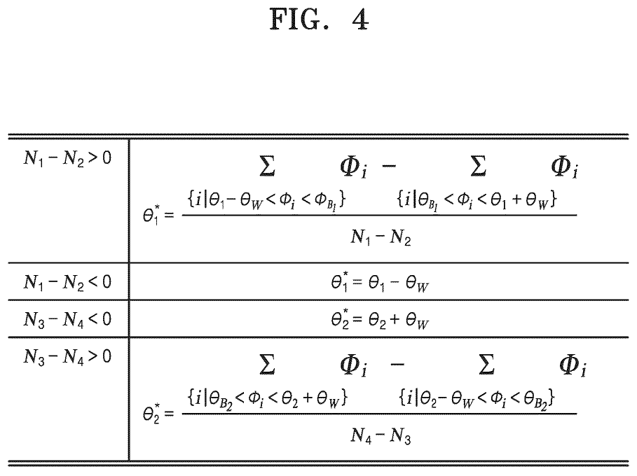

FIG. 4 is a table showing optimal (or improved) horizontal tilting angles θ*ᵢ and θ*₂ relative to the number of UEs included in clusters.

In CDT, each beam may use a bandwidth of B_{W}, and two beams may share a common frequency band. By comparison, in FFDT, a frequency band may be split, and each beam may have a bandwidth B_{W}/2. However, the CDT and the FFDT may be from the transmission (Tx) perspective of a base station. The CDT and the FFDT may have nothing to do with B_{W} from the receiving (Tx) perspective of a UE. From the viewpoint of an i-th UE, assuming that an angle of a horizontal beam in the base station, a horizontal angle of a beam in the UE, an angle of a horizontal interference beam in the base station, and an angle of a horizontal inference beam in the UE are respectively referred to as θ_{sig}, θ′_{sig,1}, θ_{inf,t}, and θ′_{inf}, a signal-to-interference-plus-noise ratio (SINR) received by the i-th UE from the base station may be a function of, θ_{sig}, θ′_{sig,1}, θ_{inf}, and θ′_{inf,t}. An optimal (or improved) beam angle that maximizes (or increases) mean cell throughput in CDT may be expressed as in the following Equation 3:

$$\text{?} \qquad [ Equation 3 ]$$

$$\text{?} \text{indicates text missing or illegible when filed}$$

During each time slot, two beams may support two UEs. Accordingly, Nₜ/2 UEs may be assigned to each beam. Assuming that each UE is connected to the beam of the strongest SINR considering only path loss and antenna gain, the angle separating the boundaries of the optimal (or improved) area formed between the two beams is, resulting in two clusters. In general, when K beams are used, K clusters may be defined. In contrast, it is assumed that an SINR is higher and

$${σ}_{n}^{2} = 0$$

to solve an optimization problem (e.g., an equation). Therefore, Equation 3 may be expressed as follows to minimize (or reduce) the function h(θ₁, θ₂).

$$\text{?} \qquad [ Equation 4 ]$$

$$\text{?} \text{indicates text missing or illegible when filed}$$

θ₁ and θ₂ of the base station θ′_{i,1} and θ′_{i,2} of the UE may be independent. Only an angle of the base station may be optimized (and/or determined) as follows:

$$\text{?} \qquad [ Equation 5 ]$$

$$\text{?} \qquad [ Equation 6 ]$$

$$\text{?} \text{indicates text missing or illegible when filed}$$

In general, in Equation 6, a function h(θ₁, θ₂) that takes both a horizontal tilting angle θ₁ and a horizontal tilting angle θ₂ as variables may be neither a convex function nor a convex function. Accordingly, only local solutions may be obtained when a full-search method cannot be (or is not) applied. Herein, the term “solution” refers to an optimal (or improved) horizontal tilting angle (θ*₁, θ*₂). To overcome the above-described challenge, in Equation 6, a solution may be obtained by repeating a process of fixing θ₁ (e.g., treating θ₁ as a constant), determining that minimizes (or reduces) h₁(θ₁, θ₂), fixing θ₂ (e.g., treating θ₂ as a constant), determining θ₁ that minimizes (or reduces) h₂(θ₁, θ₂). As described below, in an algorithm proposed according to the inventive concepts, the above-described operations may be repeated m times. As an example, when two clusters (e.g., a first cluster and a second cluster) corresponding to two regions are specified by arbitrary (or alternatively, given) values θ₁ and θ₂, an equation for obtaining an optimal (or improved) horizontal tilting angle θ*₁ may be expressed as in the following Equation 7:

$$\text{?} \qquad [ Equation 7 ]$$

$$\text{?} \text{indicates text missing or illegible when filed}$$

N₁ denotes the number of UEs in which the horizontal angle ϕᵢ satisfies the inequality ƒ₁−θ_{W}<ϕᵢ<θ_{B}_{₁}, and N₂ denotes the number of UEs in which the horizontal angle ϕᵢ satisfies the inequality θ_{B}_{₁}<ϕᵢ<θ₁+θ_{W}. In other words, N₁ denotes the number of UEs in which a beam with the horizontal tilting angle θ₁ becomes a desired signal (e.g., a beam with the horizontal tilting angle θ₂ becomes an interference signal), and N₂ denotes the number of UEs in which a beam with a horizontal tilting angle θ₂ becomes a desired signal (e.g., a beam with a horizontal tilting angle θ₁ becomes an interference signal). Accordingly, Equation 7 may be divided into a case where N₁-N₂ is greater than 0 and a case where N₁-N₂ is less than 0.

Specifically, when N₁-N₂>0, h(θ₁, θ₂) may be developed as shown in the following Equation 8:

$$\text{?} \qquad [ Equation 8 ]$$

$$\text{?} \text{indicates text missing or illegible when filed}$$

f(θ₁) may be a function that treats θ₂ as a fixed constant and uses θ₁ as a variable and represents h₁(θ₁, θ₂). When N₁-N₂>0, f(θ₁) may correspond to a convex function.

As a result, an optimal (or improved) horizontal tilting angle θ*₁ according to Equation 8 is as shown in the following Equation 9:

$$\text{?} \qquad [ Equation 9 ]$$

$$\text{?} \text{indicates text missing or illegible when filed}$$

Moreover, if N₁-N₂<0, f(θ₁) may correspond to a concave function. When N₁-N₂<0, θ₁−θ_{W} or θ_{B}_{₁} which produces a smaller value of f(θ₁), from among values of f(θ₁) that are obtained by substituting θ₁-θ_{W} or θ_{B} into θ₁, may be an optimal (or improved) horizontal tilting angle θ*₁. That is, when f(θ₁) is the concave function and θ₁ is one of values at both ends in the entire variable range (e.g., a domain) of θ₁, a minimum (or lowest) value of f(θ₁) may be obtained. Because a range of θ₁ is θ₁−θ_{W}<<ϕᵢ<θ_{B}_{₁}, θ₁-θ_{W} or θ_{B} may be substituted into θ₁. According to embodiments, because f(θ₁) always satisfies f(θ₁−θ_{W})<f(θ_{B}_{₁}) in all ranges of the variable θ₁ when N₁-N₂<0, the optimal (or improved) horizontal tilting angle θ*₁ may be expressed as in the following Equation 10:

$${θ}_{1}^{*} = {θ}_{1} - {θ}_{W} \qquad [ Equation 10 ]$$

Depending on which of N₁ and N₂ has a greater value, the optimal (or improved) horizontal tilting angle θ*₁ may be determined by either Equation 9 or Equation 10. The optimal (or improved) horizontal tilting angle θ*₂, may also be obtained in the same manner as (or a similar manner to) that described above, and redundant description is omitted.

The table of FIG. 4 shows the optimal (or improved) horizontal tilting angles θ*₁ and θ*₂ relative to the number of UEs in the first cluster and the second cluster, which are distinguished by the boundary angles θ_{B}_{₁} and θ_{B}_{₂}. As an example, each of the first cluster and the second cluster may correspond to a group of UEs included in each of a first region and a second region of a single cell, which are distinguished by the boundary angle θ_{B}_{₁} or θ_{B}_{₂}, N₃ denotes the number of UEs in which a horizontal angle ϕᵢ satisfies an inequality θ₂−θ_{W}<ϕᵢ<θ_{B}_{₂}, and N₄ denotes the number of UEs in which the horizontal angle ϕᵢ satisfies an inequality θ_{B}_{₂}<ϕᵢ<θ₂+θ_{W}.

Referring to FIGS. 3A and 4, assuming that Case 1 corresponds to a beam pattern to which an SLL is not applied, N₁=N₃ and N₂=N₄ may be satisfied. In this case, if N₁-N₂>0, the optimal (or improved) horizontal tilting angles θ*₁ and θ*₂ may satisfy the following Equations 11 and 12:

$$\text{?} \qquad [ Equation 11 ]$$

$${θ}_{2}^{*} = {θ}_{2} + {θ}_{W} = {ϕ}_{i}^{max} \qquad [ Equation 12 ]$$

$$\text{?} \text{indicates text missing or illegible when filed}$$

If N₁-N₂<0, the optimal (or improved) horizontal tilting angles θ*₁ and θ*₂ may satisfy the following Equations 13 and 14:

$${θ}_{1}^{*} = {θ}_{1} - {θ}_{W} = {ϕ}_{i}^{min} \qquad [ Equation 13 ]$$

$$\text{?} \qquad [ Equation 14 ]$$

$$\text{?} \text{indicates text missing or illegible when filed}$$

Accordingly, in Case 1, there may be two local optimums (or solutions) corresponding to two situations (N₁-N₂>0 or N₁-N₂<0).

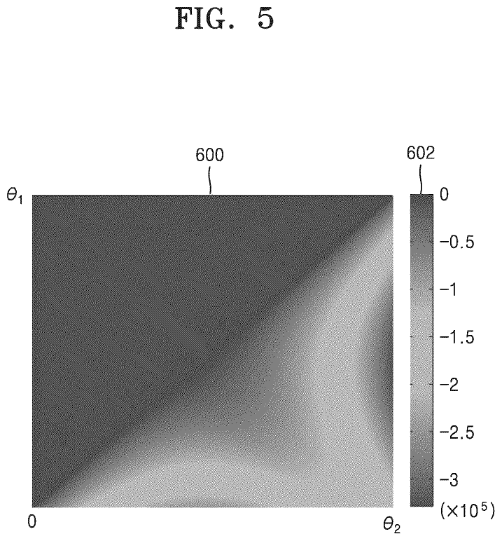

FIG. 5 illustrates an example of a graph 600 showing h(θ₁, θ₂) in a double-beam pattern to which an SLL is not applied.

FIG. 5 illustrates an example of a graph showing h(θ₁, θ₂) when 1000 horizontal tilting angles θ₁ and 1000 horizontal tilting angles θ₂ are sampled under a condition of

$${ϕ}_{i}^{min} < {θ}_{1} < {θ}_{2} < {ϕ}_{i}^{max}$$

considering Case 1 corresponding to a beam pattern to which an SLL is not applied. In a portion of θ₁≥θ₂, which is outside the above-described range, a value of h(θ₁, θ₂) may be fixed to 0. h(θ₁, θ₂) may include two convex portions, and there may be two local solutions. Referring to a graph 602 showing the scale of h(θ₁, θ₂), h(θ₁, θ₂) may have a negative value according to two tilting angles θ₁ and θ₂, which are variables, in the range of

$${ϕ}_{i}^{min} < {θ}_{1} < {θ}_{2} < {ϕ}_{i}^{max} .$$

In a method of obtaining optimal (or improved) tilting angles θ*₁ and θ*₂ and according to embodiments, similar to a K-mean clustering algorithm, the tilting angle θ₂ may be fixed (e.g., treated as a constant), the tilting angle θ₁ that minimizes (or reduces) h(θ₁, θ₂) may be determined, the tilting angle θ₂ may be fixed (e.g., treated as a constant), and the tilting angle θ₂ that minimizes (or reduces) h₂(θ₁, θ₂) may be determined. However, as compared with the K-mean clustering algorithm in which an objective function may be given only as a function of a distance from a central point in each cluster, in a KIA algorithm according to embodiments, factors (e.g.,

$${θ}_{inf}^{( i )} )$$

caused by interference between beams may be further reflected in an objective function. That is, IBI between different beams may be included as a variable of the objective function.

However, in a method of obtaining an optimal (or improved) horizontal tilting angle, according to embodiments, a single optimal (or improved) solution may not be obtained due to the characteristics of the method, optimization (or calculation) may be repeatedly performed (e.g., up to m times) from any number of starting points, and thus, an optimal (or improved) solution may be selected from a plurality of obtained solutions.

In both FFDT and conventional one beam tilting (COT), optimal (or improved) solutions may be obtained under a special condition (e.g., N₂=N₃=0 in KIA). The COT may refer to a method of adjusting one beam. That is, there may be no interference between beams in the case of N₂=N₃=0. In addition, the COT may correspond to not only a case (K=1) in which the number of clusters is 1 in a proposed algorithm but also a special condition (e.g., N₂=N₃=0).

According to embodiments, an UE may not be disconnected from a primary cell. In this case, a range of an angle of a beam with respect to the primary cell may be limited. Moreover, in terms of a receiving beam, because FFDT is not related to a bandwidth, the more beams there may be, the better. In terms of a base station, there may be cases in which COT outperform CDT depending on a distribution of UEs.

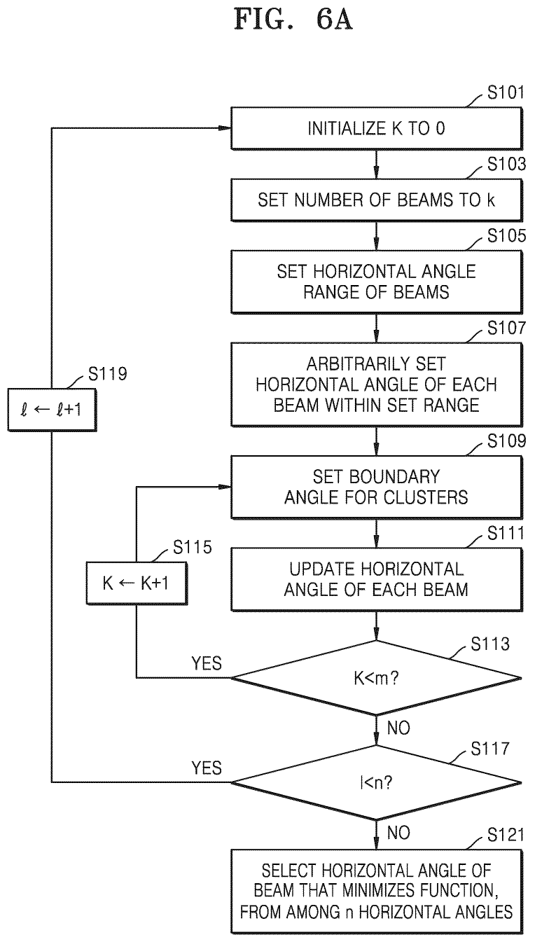

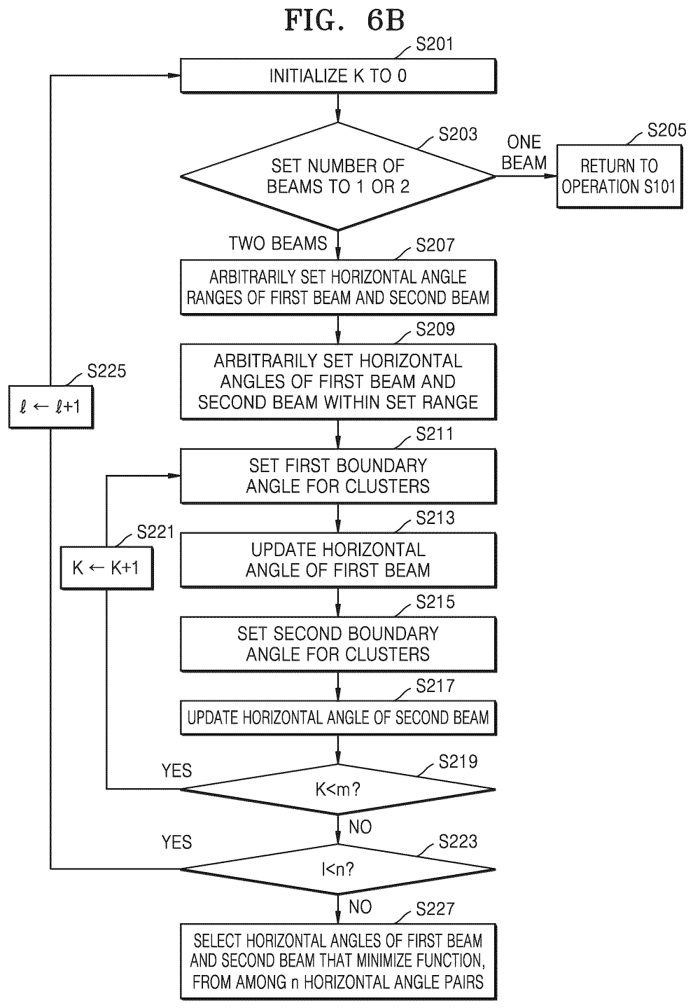

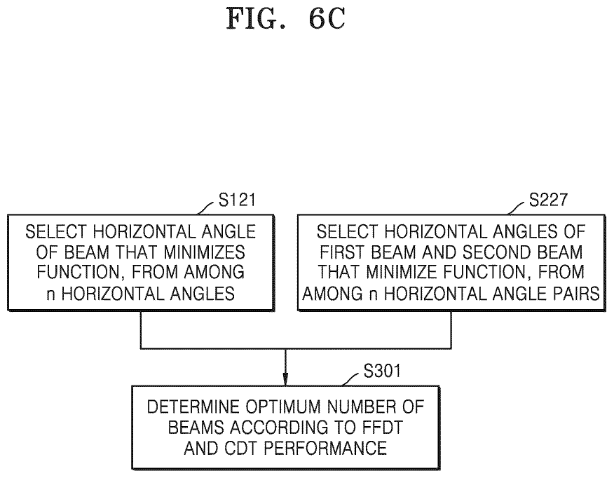

A practical K-means interference avoidance (P-KIA) algorithm according to embodiments may execute a KIA for COT in parallel to execute a KIA for CDT. Hereinafter, sequences of a P-KIA algorithm are described in detail with reference to FIGS. 6A to 6C.

In addition, a P-KIA according to embodiments may perform FFDT and CDT in parallel.

FIG. 6A is a flowchart of a P-KIA algorithm for FFDT for obtaining an optimal (or improved) horizontal tilting angle of a double-beam pattern.

FIG. 6A may be understood with reference to Equations described above. The P-KIA algorithm for FFDT of FIG. 6A may be applied to both a transmission beam and a receiving beam. For example, the P-KIA algorithm for FFDT of FIG. 6A may be applied to a transmission beam adjustment operation of a base station or a receiving beam adjustment operation of a UE. The base station may determine horizontal angles of k transmission beams by using the P-KIA algorithm for FFDT. The UE may determine horizontal angles of k receiving beams by using the P-KIA algorithm for FFDT. When the UE determines horizontal angles of k receiving beams by using a P-KIA algorithm for FFDT, there may be no interference between the receiving beams. Thus, it may be seen that a horizontal tilting angle may be determined based on a K-mean clustering algorithm that uses an SINR as an objective function and uses horizontal tilting angles of the receiving beams as variables. In this case, because there is no interference, an interference beam may not be used as a variable, and it may be considered as a special case of the P-KIA algorithm.

Referring to FIG. 6A, to obtain a single optimal (or improved) solution that allows the base station or the UE to cover cases of all double-beam patterns, optimization (e.g., calculation) may be repeatedly performed (e.g., up to m times) from any number of (e.g., n) starting points using equations described above. Here, n starting points may refer to n θₖ when the base station is operating, and refer to n θ′ₖ when the UE is operating. m may be an arbitrary predetermined (or alternatively, given) positive constant and refer to the total number of iterations of operations S109 to S113 described above. n may be an arbitrary predetermined (or alternatively, given) positive constant and refer to the total number of iterations of operation S101 described above.

In operation S101, K may be initialized to 0. K may be a positive integer. In embodiments, the base station may perform an initialization operation of setting K to 0. In embodiments, the UE may perform an initialization operation of setting K to 0.

In S103, the number k of beams may be set. Herein, k may be a positive integer greater than 1. In embodiments, the base station may set k to an arbitrary (or alternatively, given) value. In embodiments, the UE may set k to an arbitrary (or alternatively, given) value.

In operation S105, a range of horizontal angles of beams may be set. In embodiments, the base station may determine a range of a k-th transmission beam. The base station may determine values

$${ϕ}_{i}^{min} and {ϕ}_{i}^{max}$$

of a k-th beam. In embodiments, the UE may determine a range of a k-th receiving beam. The UE may determine values

$${φ}_{i}^{min} and {φ}_{i}^{max}$$

of a k-th beam. As a specific example, the UE may limit a range of a horizontal angle of a receiving beam for a primary cell.

In operation S107, a horizontal angle of each beam may be arbitrarily set (or set) within a set range. In embodiments, the base station may set an arbitrary (or alternatively, given) value θₖ that satisfies the inequality

$${ϕ}_{i}^{min} < {θ}_{k} < {ϕ}_{i}^{max}$$

In embodiments, the UE may set an arbitrary (or alternatively, given) value

$${φ}_{i}^{max}$$

in a range greater than

$${φ}_{i}^{min}$$

and less than

$${φ}_{i}^{max} .$$

In S109, a boundary angle for clusters may be set. In embodiments, the base station may set a boundary angle θ_{B}_{ₖ} for clusters (θₖ−θ_{W}<ϕᵢ<θ_{B}_{ₖ}). In embodiments, the UE may set a boundary angle θ′_{B}_{ₖ} for clusters (θ′ₖ−θ′_{W}<ϕᵢ<θ′_{B}_{ₖ}).

In operation S111, a horizontal angle of each beam may be updated. The base station may update a horizontal angle θₖ, based on a K-mean clustering algorithm. In embodiments, the base station may update a horizontal angle θₖ of a k-th beam, based on the following Equation 15.

$${θ}_{k} = {\sum }_{{θ}_{k} - {θ}_{W} < {φ}_{i} < {θ}_{{B}_{k}}} {ϕ}_{i} / {N}_{k}$$

The UE may update a horizontal angle θ′ₖ of the k-th beam, based on the K-mean clustering algorithm. In embodiments, the UE may update the horizontal angle θ′ₖ of the k-th beam, based on the following Equation 16:

$${θ}_{k}^{′} = {\sum }_{{θ}_{k}^{′} - {θ}_{W}^{′} < {φ}_{i} < {θ}_{{B}_{k}}^{′}} {ϕ}_{i} / {N}_{k}^{′}$$

In operation S113, it may be checked whether K is less than m. In embodiments, when (e.g., in response to determining) K is less than m, the base station may increase K by 1 (operation S115) and return to operation S109. That is, the base station may obtain an optimal (or improved) horizontal beam angle by updating the arbitrarily set (or set) horizontal angle θₖ m times. In embodiments, when (e.g., in response to determining) K is less than m, the UE may increase K by 1 (operation S115) and return to operation S109. That is, the UE may obtain an optimal (or improved) horizontal beam angle by updating the arbitrarily set (or set) horizontal angle θ′ₖ m times.

In operation S117, it may be checked whether 1 is less than n. 1 may be initialized to 1. In embodiments, the base station may increase 1 by 1 when (e.g., in response to determining) 1 is less than n (S119), and return to operation S101. The base station may obtain n horizontal angles by repeating operations S101 to S117 n times.

In embodiments, the UE may increase 1 by 1 when (e.g., in response to determining) 1 is less than n (operation S119), and return to operation S101. The UE may obtain n horizontal angles by repeating operations S101 to S117 n times.

In operation S121, a horizontal angle of a beam that minimizes (or results in a lowest solution to) a function may be selected from n horizontal angle pairs. In embodiments, the base station may determine an optimal (or improved) horizontal angle θ*ₖ (e.g., a local optimal solution) by selecting θₖ that minimizes (or results in a lowest solution to) h(θ₁, θ₂), from among n horizontal angles θₖ. In embodiments, the UE may determine an optimal (or improved) horizontal angle θ′*ₖ by selecting a horizontal angle θ*ₖ that minimizes (or results in a lowest solution to) h(θ′₁, θ′₂), from among n horizontal angles θ′ₖ.

In the base station and the UE, which use the P-KIA algorithm, and operating methods thereof according to embodiments, a horizontal angle of at least one beam may be adjusted based on FFDT in which respective beams have different frequency bands by splitting the entire frequency band.

The UE according to embodiments may remain connected to the primary cell. As a specific example, in operation S103, when k=2, the UE may horizontally tilt each of receiving beams with respect to one primary cell and one secondary cell. The UE may remain connected to the primary cell by limiting a range of a horizontal angle of the receiving beam with respect to the primary cell. The UE may limit the range of the horizontal angle of the receiving beam such that an SINR of the primary cell does not drop below a specific value.

The UE according to embodiments may adjust a horizontal angle of one receiving beam. As a specific example, in operation S103, the UE may set k to 1 (k=1). Accordingly, the UE may adjust an angle of a horizontal receiving beam (e.g., only a single horizontal receiving beam), based on a COT technique.

The base station according to embodiments may adjust a horizontal angle of one transmission beam (e.g., only a single transmission beam). As a specific example, in operation S103, the UE may set k to 1 (k=1).

FIG. 6B is a flowchart of a P-KIA algorithm for CDT for obtaining an optimal (or improved) horizontal tilting angle of the double-beam pattern of FIGS. 3A to 3F.

Referring to FIG. 6B, to obtain a single optimal (or improved) solution that allows a base station to cover cases of all double-beam patterns, optimization (or calculation) may be repeatedly performed (e.g., up to m times) from any number of (e.g., n) starting points using equations described above. Here, n starting points may mean n pairs (e.g., n (θ₁, θ₂) of θ₁ and θ₂. m may be an arbitrary predetermined (or alternatively, given) positive constant that may denote a total number of iterations of operations S211 to S119 described below. n may be an arbitrary predetermined (or alternatively, given) positive constant that may denote a total number of iterations of operation S201 described below.

In operation S201, K may be initialized to 0. K may be a positive integer. In embodiments, the base station may initialize K to 0.

In operation S203, the number of beams (may also be referred to herein as the quantity of beams) may be set to 1 or 2. The base station may determine the number of beams to be 1 or 2 depending on a situation. In embodiments, when the base station determines the number of beams to be 1, an operation of the case of k=1 may be performed in FFDT. That is, when the base station determines (e.g., in response to the base station determining) the number of beams to be 1, operation S101 of FIG. 6A may be performed (S205). In operation S103, k may be 1. Accordingly, the base station may adjust a horizontal angle of beams, based on a COT technique.

In operation S207, a horizontal angle range of each of a first beam and a second beam may be set. The base station may determine a minimum (or lowest) value and a maximum (or highest) value of each of the first beam and the second beam. For example, the base station may determine

$${ϕ}_{i}^{min} and {ϕ}_{i}^{max}$$

of the first beam and the second beam.

In operation S209, the horizontal angle of each of the first beam and the second beam may be arbitrarily set (or set) within a set range. The base station may set the first beam and the second beam within a set range. For example, the base station may set arbitrary (or otherwise, given) values θ₁ and θ₂ that satisfy the inequality

$${ϕ}_{i}^{min} < {θ}_{1} < {θ}_{2} < {ϕ}_{i}^{max} .$$

In operation S211, a first boundary angle for clusters may be set. The base station may set the first boundary angle that divides the clusters. In embodiments, the base station may set a first and that satisfy the inequality boundary angle θ_{B}_{₁} for clusters (θ₁−θ_{W}<ϕᵢ<θ_{B}_{₁}, θ_{B}_{₁}<ϕᵢ<θ₁+θ_{W}).

In S213, a horizontal angle of the first beam may be updated. The base station may update a horizontal angle θ₁ of the first beam, based on the following Equation 17:

### [Equation 17]

$$if {N}_{1} - {N}_{2} > 0 , {θ}_{1} ( {\sum }_{\text{?}} {ϕ}_{i} - {\sum }_{\text{?}} {ϕ}_{i} ) / ( {N}_{1} - {N}_{2} ) else {θ}_{1} ← {θ}_{1} - {θ}_{W} .$$

$$\text{?} \text{indicates text missing or illegible when filed}$$

That is, the base station may substitute

$$( {\sum }_{\text{?}} {ϕ}_{i} - {\sum }_{\text{?}} {ϕ}_{i} ) / ( {N}_{1} - {N}_{2} )$$

$$\text{?} \text{indicates text missing or illegible when filed}$$

into θ₁ if N₁-N₂>0, and may substitute θ₁-θ_{W} into θ₁ if N₁-N₂ is less than or equal to 0.

In operation S215, a second boundary angle for clusters may be set. The base station may set the second boundary angle that divides the clusters. In embodiments, the base station may set a second boundary angle θ_{B}_{₂} for clusters (θ₂−θ_{W}<ϕᵢ<θ_{B}_{₂}, θ_{B}_{₂}<ϕᵢ<θ₂+θ_{W}).

In S217, a horizontal angle of the second beam may be updated. The base station may update a horizontal angle θ₂ of the second beam, based on the following Equation 18:

$$if {N}_{1} - {N}_{2} > 0 , {θ}_{2} ← {θ}_{2} + {θ}_{W} else , {θ}_{2} = ( {\sum }_{\text{?}} {ϕ}_{i} - {\sum }_{\text{?}} {ϕ}_{i} ) / ( {N}_{4} - {N}_{3} )$$

$$\text{?} \text{indicates text missing or illegible when filed}$$

That is, the base station may substitute θ₂+θ_{W} into θ₂ if N₃-N₄>0, and substitute

$$( {\sum }_{\text{?}} {ϕ}_{i} - {\sum }_{\text{?}} {ϕ}_{i} ) / ( {N}_{4} - {N}_{3} )$$

$$\text{?} \text{indicates text missing or illegible when filed}$$

into θ₂ if N₃-N₄ is equal to or less than 0.

In operation S219, it may be checked whether K is less than m. The base station may increase K by 1 when K is less than m (operation S221) and return to operation S211. That is, the base station may obtain an optimal (or improved) horizontal beam angle by updating the arbitrarily set (or set) horizontal angle of each of the first beam and the second beam m times.

In operation S223, it may be checked whether 1 s less than n. 1 may be initialized to 1. The base station may increase 1 by 1 when 1 is less than n (operation S225) and return to operation S201. The base station may obtain n horizontal angle pairs by repeating operations S201 to S223 n times.

In S227, horizontal angles of the first beam and the second beam that minimize (or result in a lowest solution to) a function may be selected from n horizontal angle pairs. The base station may determine optimal (or improved) horizontal angles θ*₁ and θ*₂ by selecting horizontal angles θ₁ and θ₂ that minimizes (or result in a lowest solution to) h(θ₁, θ₂), from among n horizontal angles 1 and

Because θ_{B}_{₁}=θ_{B}_{₂}=θ_{B} in Case 1 and Case 2, when double-beam patterns correspond to Case 1 and Case 2, operations S215 and S217 described above may be omitted.

Accordingly, when the number of beams is set to 1, the base station according to embodiments may adjust a horizontal angle of a beam, based on COT, and determine an optimal (or improved) horizontal tilting angle of double beams or one beam, which include a horizontal beam, by using a P-KIA algorithm considering IBI between the double beams. Therefore, optimization (or calculation) may be performed on multiple horizontal beams in all cases with a typical beam pattern, thereby improving the cell throughput and load balancing performance of the base station.

FIG. 6C is a flowchart of a P-KIA algorithm by which FFDT and CDT are performed in parallel.

Referring to FIG. 6C, in operation S121, a horizontal angle of a beam that minimizes (or results in a lowest solution to) a function may be selected from n horizontal angle pairs. A base station may select a horizontal angle of a beam that minimizes (or results in a lowest solution to) a function, from among n horizontal angle pairs.

In operation S227, horizontal angles of the first beam and the second beam that minimize (or result in a lowest solution to) a function may be selected from n horizontal angle pairs. The base station may determine optimal (or improved) horizontal angles θ*₁ and θ*₂ by selecting θ₁ and θ₂ that minimizes (or result in a lowest solution to) h(θ₁, θ₂) from among n θ₁ and θ₂.

In operation S301, an optimal (or improved) number of beams may be determined depending on FFDT and CDT performance. The base station may select an optimal (or improved) number of beams, based on performance according to the result of operation S121 (refer to FIG. 6A) and performance according to the result of operation S227 (refer to FIG. 6B). According to embodiments, the base station may compare the result of operation S121 and the result of operation S227 to determine the number of beams providing the highest cell throughput. For example, the base station may select an optimal (or improved) number of beams with highest cell throughput.

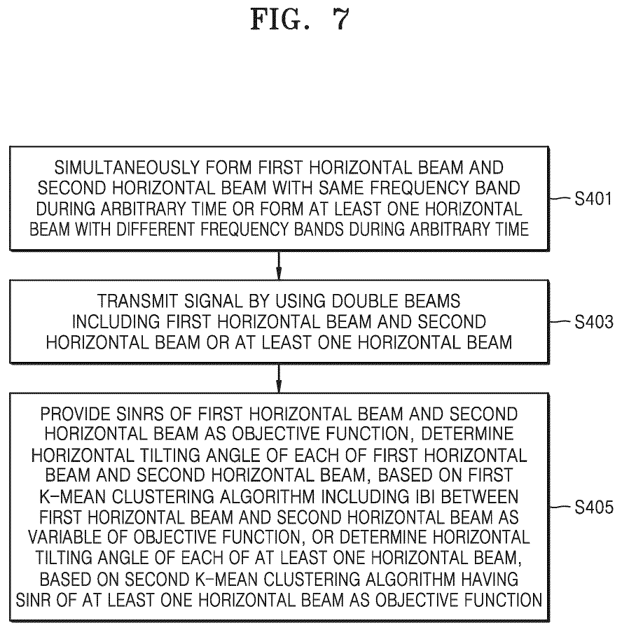

FIG. 7 illustrates an operating method of a base station, according to embodiments.

Referring to FIG. 7, in operation S401, a base station may simultaneously (or contemporaneously) form a first horizontal beam and a second horizontal beam with the same frequency band (or similar frequency bands) during an arbitrary (or alternatively, given) time period, or form at least one horizontal beam having different frequency bands during an arbitrary (or alternatively, given) time period.

In operation S403, the base station may transmit signals by using double beams including the first horizontal beam and the second horizontal beam, or the at least one horizontal beam.

In operation S405, the base station may determine a horizontal tilting angle of each of the first horizontal beam and the second horizontal beam, based on a first K-mean clustering algorithm, or determine a horizontal tilting angle of each of the at least one horizontal beam, based on a second K-mean clustering algorithm. The first K-mean clustering algorithm may have SINRs of the first horizontal beam and the second horizontal beam as an objective function and include IBI between the first horizontal beam and the second horizontal beam as a variable of the objective function. The second K-mean clustering algorithm may have an SINR of the at least one horizontal beam as the objective function. The first K-mean clustering algorithm may correspond to a P-KIA algorithm for the CDT described with reference to FIG. 6B. The second K-mean clustering algorithm may correspond to a P-KIA algorithm for the FFDT described with reference to FIG. 6B. According to embodiments, after determining the horizontal tilting angle(s) of one or more beams in operation S405 (and/or S121 and/or S227), the base station (or UE) may apply the determined horizontal tilting angle(s) at a corresponding antenna(s). For example, the determined horizontal tilting angle(s) may be applied mechanically by physically moving the antenna(s) horizontally, or electronically by adjusting a phase(s), a gain(s) (e.g., beamforming parameters) to direct a formed beam horizontally. According to embodiments, after applying the determined horizontal tilting angle(s), the base station (or UE) may perform wireless communication with another device. For example, the base station (or UE) may generate a first signal, process the first signal to perform one or more among modulating, upconverting, filtering, amplifying and/or encrypting on the first signal, and transmit the processed first signal to the other device via the corresponding antenna(s). Additionally or alternatively, the base station (or UE) may receive a second signal from the other device via the corresponding antenna(s), process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application executing on the base station (or UE), storing the processed second signal, sending a response signal to the other device (e.g., based on a processing result of the corresponding application executing on the base station (or UE)), etc.

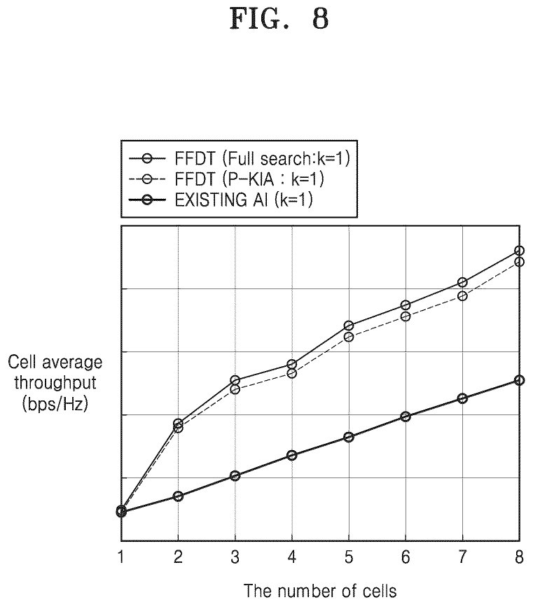

FIG. 8 is a graph of mean cell throughput relative to the number of cells, according to embodiments.

Referring to FIG. 8, the number of cells refers to a plurality of cells including a primary cell and a secondary cell. FIG. 7 illustrates a case in which the number of receiving beams for a UE is 1 (k=1). When the number of receiving beams for the UE is 1, battery may be saved. However, when the number of receiving beams for the UE is 1 and the primary cell and the secondary cell are at different positions, the UE may not be connected to the secondary cell. When the UE is based on FFDT, the UE may be connected to the secondary cell even though the primary cell has a lower SINR. In this case, because the primary cell should not be disconnected from the UE, a horizontal angle of a beam may be adjusted such that the SINR of the primary cell does not drop below-6 dB. For example, a range

$$( {ϕ}_{i}^{min} < {θ}_{k} < {ϕ}_{i}^{max} )$$

of the horizontal angle may be set such that the SINR of the primary cell does not drop below-6 dB.

Referring to FIG. 8, when only the primary cell is connected to the UE (e.g., the number of cells is 1), the same FFDT performance as (or a similar FFDR performance to) that in an existing algorithm may be obtained. However, when the secondary cell is present (e.g., the number of cells is 2 or more) a receiving beam may indicate a boundary between the primary cell and the secondary cell. Therefore, the primary cell and the secondary cell may have lower SINRs. However, the UE may use carrier aggregation. When the number of cells is 2 or more, the performance of using FFDT may be similar to the performance of full-search. The full-search may refer to a search with performance obtained when all cases are considered without an algorithm.

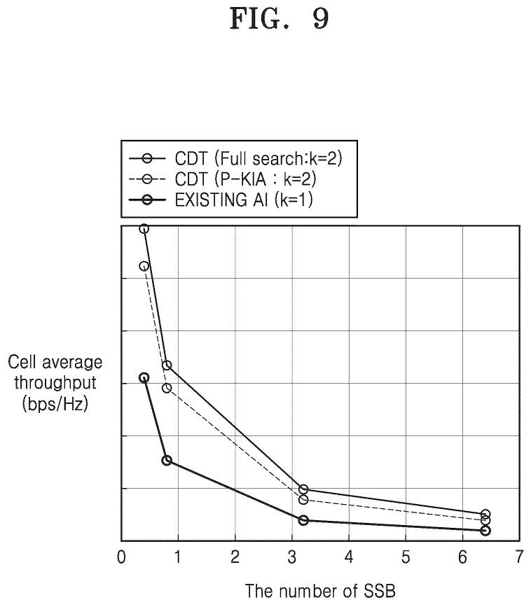

FIG. 9 is a graph of a mean cell throughput relative to the number of synchronization signal blocks (SSBs), according to embodiments.

Referring to FIG. 9, the number of transmission beams in a base station may be assumed to be two in CDT (k=2 in CDT). As described above, when the base station is based on CDT, the COT may be used in parallel. Thus, based on a P-KIA algorithm, the base station may select an optimal (or improved) number of beams by comparing performance according to the result of operation S121 (refer to FIG. 6A) with performance according to the result of operation S227 (refer to FIG. 6B). As the number of SSBs increases, a beamwidth may be gradually reduced. As a result, performance may be reduced. Referring to FIG. 9, it may be seen that the performance of using the CDT is similar to the performance of full-search.

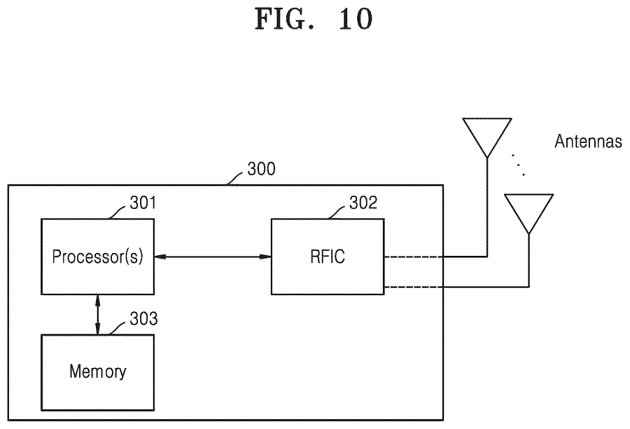

FIG. 10 is a block diagram of a configuration of a wireless communication device 300 according to embodiments.

Referring to FIG. 10, the wireless communication device 300 may include a processor 301, a radio-frequency integrated circuit (RFIC) 302, and/or a memory 303.

The processor 301 may control all operations of the wireless communication device 300. For example, the processor 301 may transmit and receive signals to/from another wireless communication device through the RFIC 302. Also, the processor 301 may write and read data to and from the memory 303. In addition, the processor 301 may perform functions of a protocol stack required (or otherwise, used) by the communication standard. Each of the processor 301, the RFIC 302, and the memory 303 is illustrated as one block for brevity, but the wireless communication device 300 according to embodiments may include a plurality of processors, a plurality of RFICs, and a plurality of memories. The processor 301 may control the wireless communication device 300 to perform operations according to embodiments.

The RFIC 302 may perform functions for transmitting and receiving signals. For example, the RFIC 302 may perform a conversion function between a baseband signal and a bitstream according to physical layer specifications of a system. For example, during data transmission, the RFIC 302 may generate complex symbols by encoding and modulating transmitted bitstreams. In addition, the RFIC 302 may up-convert the baseband signal into an RF band signal, transmit to another wireless communication device the RF band signal through an antenna, and down-convert an RF band signal received through the antenna into a baseband signal. The RFIC 302 may include a transmission filter, a receiving filter, an amplifier, a mixer, an oscillator, a digital-to-analog converter (DAC), and/or an analog-to-digital converter (ADC).

The memory 303 may store data (e.g., basic programs, applied programs, and/or setting information) for operations of the wireless communication device 300. The memory 303 may include volatile memory, non-volatile memory, or a combination of the volatile memory and the non-volatile memory. The memory 303 may provide the stored data to the processor 301 upon request of the processor 301.

The wireless communication device 300 according to embodiments may correspond to a UE (refer to 211 in FIG. 2A). The UE 211 may include an antenna array, the RFIC 302, and/or the processor 301. The antenna array may be configured to form at least one horizontal beam with different frequency bands during an arbitrary (or alternatively, given) time period. The RFIC 302 may be configured to receive a signal using the at least one horizontal beam. The processor 301 may determine the number of the at least one horizontal beam for receiving the signal, and determine a horizontal tilting angle of each of the at least one horizontal beam, based on a K-mean clustering algorithm having an SINR of the at least one horizontal beam as an objective function. According to embodiments, the processor 301 may determine that the number of the at least one horizontal beam is 1, the at least one horizontal beam may be a first horizontal beam, and a horizontal tilting angle of the first horizontal beam may be determined within a horizontal tilting angle range for maintaining a connection between the primary cell and the UE. According to embodiments, the processor 301 may determine that the number of the at least one horizontal beam is 2 or more. The antenna array may simultaneously (or contemporaneously) form the at least one horizontal beam (e.g., the 2 or more horizontal beams) during the arbitrary (or alternatively, given) time period. According to embodiments, the processor 301 may cluster a plurality of cells including the primary cell and at least one secondary cell, based on the K-mean clustering algorithm. The processor 301 may determine a horizontal tilting angle of one first beam, from among the at least one horizontal beam, within a horizontal tilting angle range for maintaining the connection with the primary cell.

The wireless communication device 300 according to embodiments may correspond to a base station (refer to 200 in FIG. 2A). The base station 200 may include an antenna array, the RFIC 302, and/or the processor 301. The antenna array may simultaneously (or contemporaneously) form a first horizontal beam and a second horizontal beam with the same frequency band (or similar frequency bands) during an arbitrary (or alternatively, given) time period, or form at least one horizontal beam with different frequency bands during an arbitrary (or alternatively, given) time period. The RFIC 302 may transmit a signal using double beams including the first horizontal beam and the second horizontal beam, or the at least one horizontal beam. The processor 301 may determine a horizontal tilting angle of each of the first horizontal beam and the second horizontal beam, based on a first K-mean clustering algorithm or determine a horizontal tilting angle of each of the at least one horizontal beam, based on a second K-mean clustering algorithm. The first K-mean clustering algorithm may have SINRs of the first horizontal beam and the second horizontal beam as an objective function, and include IBI between the first horizontal beam and the second horizontal beam as a variable of the objective function. The second K-mean clustering algorithm may have an SINR of the at least one horizontal beam as an objective function. According to embodiments, the processor 301 may compare a first result, which is based on the determination of the horizontal tilting angle of each of the first horizontal beam and the second horizontal beam, with a second result, which is based on the determination of the horizontal tilting angle of each of the at least one horizontal beam. The processor 301 may select a result with higher cell throughput, from among the first result and the second result. When the processor 301 selects the first result (e.g., in response to selecting the first result), the antenna array may be configured to simultaneously (or contemporaneously) form the first horizontal beam and the second horizontal beam having the same frequency band (or similar frequency bands) during an arbitrary (or alternatively, given) time period, and the RFIC 302 may transmit the signal by using the double beams including the first horizontal beam and the second horizontal beam. When the processor 301 selects the second result (e.g., in response to selecting the second result), the antenna array may form at least one horizontal beam with different frequency bands during an arbitrary (or alternatively, given) time period, and the RFIC 302 may transmit a signal using at least one horizontal beam. When the processor 301 selects the first result, the processor 301 may determine a first horizontal tilting angle of the first horizontal beam, based on IBI of the second horizontal beam, and determine a second horizontal tilting angle of the second horizontal beam, based on IBI of the first horizontal beam. When the processor 301 selects the second result and determines that the number of the at least one horizontal beam is 1, the at least one horizontal beam may be a third horizontal beam, and a horizontal tilting angle of the third horizontal beam may be determined within a horizontal tilting angle range for maintaining a connection with the primary cell. When the processor 301 selects the second result and determines that the number of the at least one horizontal beam is 2 or more, the antenna array may simultaneously (or contemporaneously) form the at least one horizontal beam during the arbitrary (or alternatively, given) time period.

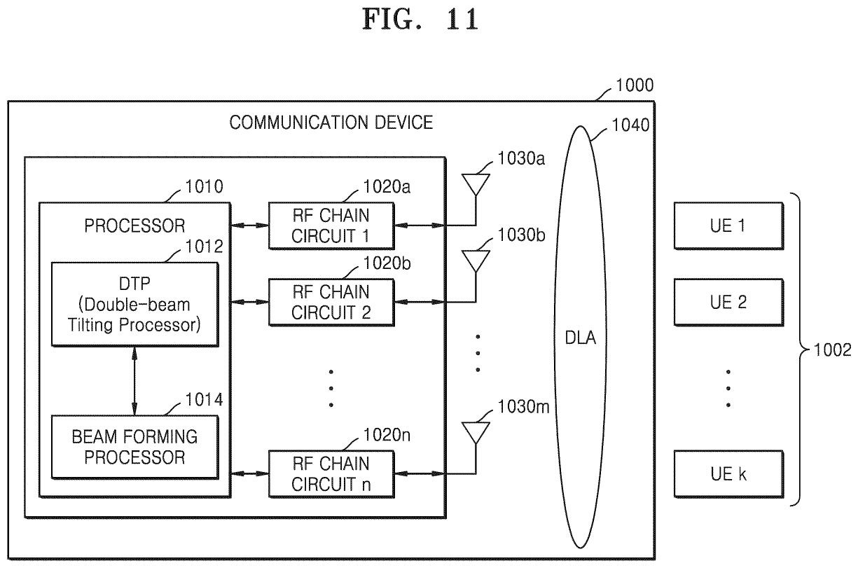

FIG. 11 is a block diagram of a configuration of a communication device 1000 according to embodiments.

The communication device 1000 may include a processor 1010, a plurality of RF chain circuits (e.g., first to n-th RF chain circuits 1020a to 1020n), a plurality of antennas 1030a to 1030m, and/or a discrete lens array (DLA) 1040. Although not shown, the communication device 1000 may further include a transceiver including at least one digital-to-analog converter (DAC) and/or at least one ADC. Each of components included in the communication device 1000 may be a hardware block, which is designed through logic synthesis and includes an analog circuit and/or a digital circuit. Alternatively, each of the communications included in the communication device 1000 may be a software block including a plurality of instructions executed by at least one processor.

In embodiments, the processor 1010 may include a double-beam tilting processor (DTP) 1012 and/or a beamforming processor 1014. The processor 1010 may be a baseband processor configured to control and/or process a baseband signal. The processor 1010 may generate data corresponding to each of UEs 1002 as a transmission signal, and form beams by using the DTP 1012 and the beamforming processor 1014. As an example, the DTP 1012 is not limited to two beams (or double beams), and may determine an optimal (or improved) horizontal tilting angle of one horizontal beam or a plurality of horizontal beams. The beamforming processor 1014 may determine beamforming for transmitting a signal by using uplink channel information estimated from a reference signal received from each of the UEs 1002. The DTP 1012 may select a horizontal angle of a beam that minimizes (or results in a lowest solution to) an objective function, from among n horizontal angles, as described with reference to FIGS. 6A to 6C. Specifically, the DTP 1012 may determine a horizontal tilting angle of each of at least one horizontal beam, based on a K-mean clustering algorithm having an SINR of the at least one horizontal beam as an objective function.

The first to n-th RF chain circuits 1020a to 1020n may be circuits configured to amplify signals generated by the processor 1010 or remove noise from the signals, and may be collectively referred to as a plurality of RF chain circuits. As an example, an RF chain circuit may include a band pass filter (BPF), a low noise amplifier (LNA), a mixer, an amplifier, and/or a down-converter.

In addition, the number of the first to n-th RF chains 1020a to 1020n may be less than the number of the antennas 1030a to 1030m. When the number of the first to n-th RF chains 1020a to 1020n is less than the number of the antennas 1030a to 1030m, the communication device 1000 may select antennas in equal number to the number of the RF chain circuits 1020a to 1020n and transmit signals to the DLA 1040 through the selected antennas.

The DLA 1040 may generate a beamforming signal by refracting signals output from the plurality of antennas 1030a to 1030m. A degree to which a signal is refracted through the DLA 1040 may vary according to a location of each of the plurality of antennas 1030a to 1030m. Accordingly, the communication device 1000 may transmit the signal to a location of each of the UEs 1002, based on beamforming.

The plurality of antennas 1030a to 1030m may include at least one antenna, and receive an RF signal from at least one UE 1002 or transmit the RF signal to the at least one UE 1002. In embodiments, the plurality of antennas 1030a to 1030m may be implemented in the form of an antenna array to support MIMO.

Each of the UEs 1002 may receive a signal transmitted from the communication device 1000 through at least one antenna. A communication system including the communication device 1000 and the UEs 1002 may be a system in which communication is performed in a multi user-multi input single output (MU-MISO) manner, but is not limited thereto. As an example, the communication system including the communication device 1000 and the UEs 1002 may be a system in which each of the UEs 1002 receives a signal from the communication device 1000 through a plurality of antennas to enable communication in the MU-MIMO manner.

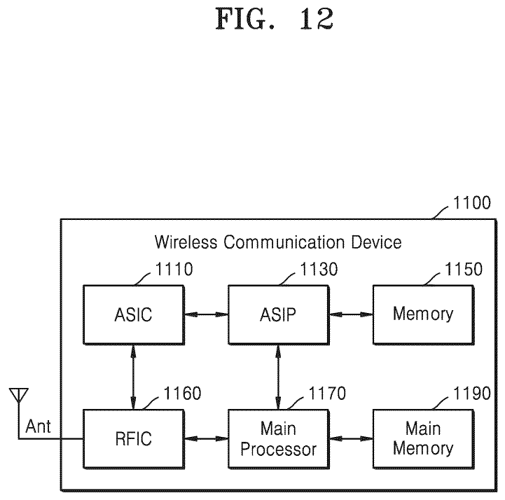

FIG. 12 is a block diagram of a communication device 1100 according to embodiments.

Referring to FIG. 12, the communication device 1100 may include a MODEM (not shown) and/or an RFIC 1160, and the MODEM may include an application specific integrated circuit (ASIC) 1110, an application specific instruction set processor (ASIP) 1130, a memory 1150, a main processor 1170, and/or a main memory 1190. The communication device 1100 of FIG. 12 may be a base station 200 according to embodiments. The communication device 1100 of FIG. 12 may include a UE 211 according to embodiments.

The RFIC 1160 may be connected to an antenna Ant, and receive or transmit signals from and to the outside (e.g., outside of the communication device 1100) using a wireless communication network. The RFIC 1160 may exchange a plurality of carrier signals with the MODEM.

The ASIP 1130, which is an IC customized for a specific purpose, may support a dedicated instruction set for a specific application and execute instructions included in the instruction set. The memory 1150 may communicate with the ASIP 1130 and serve as a non-transitory storage device that may store a plurality of instructions executed by the ASIP 1130. For example, the memory 1150 may include, but is not limited thereto, any type of memory accessible by the ASIP 1130, such as random access memory (RAM), read-only memory (ROM), a tape, a magnetic disc, an optical disk, volatile memory, non-volatile memory, and/or a combination thereof.

The main processor 1170 may control the communication device 1100 by executing the plurality of instructions. For instance, the main processor 1170 may control the ASIC 1110 and/or the ASIP 1130 and process received data through a wireless communication network or process users' inputs to the communication device 1100.

According to embodiments, the main processor 1170 may adjust horizontal angles of beams that are transmitted and received through the RFIC 1160, based on a P-KIA algorithm. For example, the main processor 1170 may perform the respective operations of FIGS. 6A to 6C.

The main memory 1190 may communicate with the main processor 1170 and serve as a non-transitory storage device that may store a plurality of instructions executed by the main processor 1170. For example, the main memory 1190 may include, but is not limited thereto, any type of memory accessible by the main processor 1170, such as RAM, ROM, a tape, a magnetic disc, an optical disk, volatile memory, non-volatile memory, and/or a combination thereof.

Conventional devices and methods for performing wireless communication are unable to perform horizontal antenna tilting with sufficient efficacy and/or are unable to perform antenna tilting based on beams of a UE in communication with a base station. As a result of these limitations, the conventional devices and methods suffer from insufficient mean cell throughput.

However, according to embodiments, improved devices and methods are provided for performing wireless communication. For example, the improved devices and methods involve clustering horizontal beams to determine a horizontal antenna tilt providing increased cell throughput. Also, the improved devices and methods may involve determining the horizontal antenna tilt based on beams of a UE in communication with a base station. Accordingly, the improved devices and methods overcome the deficiencies of the conventional devices and methods to at least increase mean cell throughput.

According to embodiments, operations described herein as being performed by the wireless communication system 100, the first network 120, the second network 125, each of the UEs 111 to 116, the first base station 101, the second base station 102, the third base station 103, the communication system 20, the base station 200, each of the plurality of UEs 211 to 216, the wireless communication device 300, the processor 301, the RFIC 302, the communication device 1000, the processor 1010, each of the plurality of RF chain circuits (e.g., first to n-th RF chain circuits 1020a to 1020n), the DTP 1012, the beamforming processor 1014, each of the at least one UE 1002, the communication device 1100, the RFIC 1160, the ASIC 1110, the ASIP 1130, and/or the main processor 1170 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above.

For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 303, the memory 1150, the main memory 1190, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items. The term “outside” refers to a region that is beyond the outermost confines of a physical object. The term “inside” indicates that at least a portion of a region is partially contained within a boundary formed by the object. According to embodiments, the term “arbitrary” may refer to a value, a selection, etc., that may be performed by processing circuitry using one or more approaches (e.g., pseudo-randomly, based on a set of given values, based on operator input, etc.).

Any of the arrows or lines that interconnect the components in the drawings may represent physical data paths, logical data paths, or both. A physical data path may comprise a data bus or a transmission line, for example. A logical data path may represent a communication or data message between software programs, software modules, subroutines, or other software constituents or components.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

While the inventive concepts have been particularly shown and described with reference to embodiments thereof, it will be understood that various changes in form and details may be made therein without departing from the spirit and scope of the following claims.

What is claimed is:

1. A user equipment (UE) comprising:
an antenna array configured to form at least one horizontal beam with different frequency bands during a first time period; and
processing circuitry configured to
receive a signal using the at least one horizontal beam,
determine a quantity of horizontal beams for receiving the signal, the at least one horizontal beam including the quantity of horizontal beams, and
determine a horizontal tilting angle of each among the at least one horizontal beam based on a K-mean clustering algorithm, the K-mean clustering algorithm having a signal-to-interference-plus-noise ratio (SINR) of the at least one horizontal beam as an objective function.

2. The UE of claim 1, wherein
the quantity of horizontal beams is 1;
the at least one horizontal beam includes a first horizontal beam; and
the processing circuitry is configured to determine the horizontal tilting angle of the first horizontal beam as being within a horizontal tilting angle range for maintaining a connection with a primary cell.

3. The UE of claim 1, wherein
the quantity of horizontal beams is two or more; and
the antenna array is configured to simultaneously form the at least one horizontal beam during the first time period.

4. The UE of claim 1, wherein the processing circuitry is configured to:
cluster a plurality of cells based on the K-mean clustering algorithm, the plurality of cells including a primary cell and at least one secondary cell; and
determine the horizontal tilting angle of a first horizontal beam among the at least one horizontal beam as being within a horizontal tilting angle range for maintaining a connection with the primary cell.

5. A base station comprising:
an antenna array configured to
simultaneously form a first horizontal beam and a second horizontal beam with a same frequency band during a first time period, or
form at least one horizontal beam with different frequency bands during the first time period; and
processing circuitry configured to
transmit a signal using
double beams including the first horizontal beam and the second horizontal beam, or
the at least one horizontal beam; and
first determine a horizontal tilting angle of each of the first horizontal beam and the second horizontal beam based on a first K-mean clustering algorithm, the first K-mean clustering algorithm including
signal-to-interference-plus-noise ratios (SINRs) of the first horizontal beam and the second horizontal beam as an objective function, and
inter-beam interference (IBI) between the first horizontal beam and the second horizontal beam as a variable of the objective function, or
second determine a horizontal tilting angle of each of the at least one horizontal beam based on a second K-mean clustering algorithm having an SINR of the at least one horizontal beam as an objective function.

6. The base station of claim 5, wherein the processing circuitry is configured to:
perform the first determination to obtain a first result;
perform the second determination to obtain a second result; and
compare the first result with the second result.

7. The base station of claim 6, wherein the processing circuitry is configured to select one among the first result and the second result corresponding to a higher cell throughput.

8. The base station of claim 6, wherein the processing circuitry is configured to:
cause the antenna array to simultaneously form the first horizontal beam and the second horizontal beam with the same frequency band during the first time period in response to selecting the first result; and
transmit the signal using the double beams in response to selecting the first result.

9. The base station of claim 6, wherein the processing circuitry is configured to:
cause the antenna array to form the at least one horizontal beam with different frequency bands during the first time period in response to selecting the second result; and
transmit the signal using the at least one horizontal beam.

10. The base station of claim 6, wherein the processing circuitry is configured to:
determine a first horizontal tilting angle of the first horizontal beam based on IBI of the second horizontal beam in response to selecting the first result; and
determine a second horizontal tilting angle of the second horizontal beam based on IBI of the first horizontal beam in response to selecting the first result.

11. The base station of claim 6, wherein
the at least one horizontal beam includes a third horizontal beam; and
the processing circuitry is configured to determine a third tilting angle of the third horizontal beam as being within a horizontal tilting angle range for maintaining a connection with a primary cell in response to selecting the second result.

12. The base station of claim 6, wherein
the at least one horizontal beam includes two or more horizontal beams; and
the processing circuitry is configured to cause the antenna array to simultaneously form the two or more horizontal beams during the first time period in response to selecting the second result.

13. An operating method of a base station, the method comprising:
forming beams, the forming of the beams including
simultaneously forming a first horizontal beam and a second horizontal beam with a same frequency band during a first time period, or
forming at least one horizontal beam with different frequency bands during the first time period;
transmitting a signal by using
double beams including the first horizontal beam and the second horizontal beam, or
the at least one horizontal beam; and
performing a first determination or a second determination, the first determination including determining a horizontal tilting angle of each of the first horizontal beam and the second horizontal beam based on a first K-mean clustering algorithm, the first K-mean clustering algorithm including
signal-to-interference-plus-noise ratios (SINRs) of the first horizontal beam and the second horizontal beam as an objective function, and
inter-beam interference (IBI) between the first horizontal beam and the second horizontal beam as a variable of the objective function,
and the second determination including determining a horizontal tilting angle of each of the at least one horizontal beam based on a second K-mean clustering algorithm having an SINR of the at least one horizontal beam as an objective function.

14. The method of claim 13, further comprising:
performing the first determination to obtain a first result;
performing the second determination to obtain a second result; and
comparing the first result with the second result.

15. The method of claim 14, further comprising:
selecting one among the first result and the second result corresponding to a higher cell throughput.

16. The method of claim 15, wherein
the forming of the beams includes the simultaneously forming of the first horizontal beam and the second horizontal beam with the same frequency band during the first time period in response to selecting the first result; and
the transmitting of the signal includes transmitting the signal by using the double beams in response to selecting the first result.

17. The method of claim 15, wherein
the forming of the beams includes the forming of the at least one horizontal beam with the different frequency bands during the first time period in response to selecting the second result; and
the transmitting of the signal includes transmitting the signal by using the at least one horizontal beam.

18. The method of claim 15, wherein the performing includes performing the first determination in response to selecting the first result, the first determination including:
determining a first horizontal tilting angle of the first horizontal beam based on IBI of the second horizontal beam; and
determining a second horizontal tilting angle of the second horizontal beam based on IBI of the first horizontal beam.

19. The method of claim 15, wherein
the at least one horizontal beam includes a third horizontal beam; and
the performing includes performing the second determination in response to selecting the second result, the second determination including determining a horizontal tilting angle of the third horizontal beam as being within a horizontal tilting angle range for maintaining a connection with a primary cell.

20. The method of claim 15, wherein
the at least one horizontal beam includes two or more horizontal beams; and
the forming of the beams includes simultaneously forming the two or more horizontal beams during the first time period.
